(19) United States
(12) Patent Application Publication
(10) Pub. No.: US 2012/0191837 A1
(43) Pub. Date: Jul. 26, 2012

(54) METHOD FOR AUTOMATICALLY IDENTIFYING POTENTIAL ISSUES WITH THE CONFIGURATION OF A NETWORK

(75) Inventors: Dominic Blatchford, London (GB); Philip Sant, London (GB)

(73) Assignee: Omnifone Ltd., London (GB)

(21) Appl. No.: 13/382,613

(22) PCT Filed: Jul. 6, 2010
(86) PCT No.: PCT/GB2010/051116

§ 371 Date: Apr. 16, 2012

(30) Foreign Application Priority Data
Jul. 6, 2009 (GB) 0911655.9

(51) Int. Cl. G06F 15/173

(52) U.S. Cl. 709/223

(57) ABSTRACT

A method, and an automated system or tool, for interrogating networks, and most significantly mobile networks, in order to identify network and gateway issues at the earliest point. The method uses the combination of a client device and a server to execute one or more test cases on the network and thereby determine those characteristics of the network which are relevant to the implementation of a network-based service on the said network. The network characteristics include one or more of data fidelity, protocol support, data timeout periods, data length restrictions and network performance.

### BACKGROUND OF THE INVENTION

1. Field of the Invention

This invention relates to a method for automatically identifying potential issues with the configuration of a network. The method facilitates the provision of networked services by automatically identifying potential issues with the configuration of networks, including mobile networks and any gateways to those networks.

2. Technical Background

Rolling out any network-based service across different network types has historically presented a variety of networking issues. Such issues are particularly evident when dealing with separate Mobile Network Operators (MNOs), due to inconsistencies of the gateway infrastructure that MNOs provide.

The absence of any technique which is able to reliably identify such relevant inconsistencies has historically represented a significant impediment to the provision of services which need to operate across multiple networks.

The present invention resolves this significant networking problem by disclosing a method, and consequently an automated tool, for interrogating networks, and most significantly mobile networks, in order to identify network and gateway issues at the earliest point, thus minimising the risk of rollout disruption when deploying a service across diverse networks.

### SUMMARY OF THE INVENTION

The present invention discloses a method, and an automated system or tool, for interrogating networks, and most significantly mobile networks, in order to identify network and gateway issues at the earliest point. By use of the method disclosed, the risks of rollout disruption when deploying a service across multiple networks are significantly reduced.

The method is a method for automatically identifying potential issues with the configuration of a network by using the combination of a client device and a server to execute one or more test cases on the network and thereby determine those characteristics of the network which are relevant to the implementation of a network-based service on the said network.

The network characteristics include one or more of data fidelity, protocol support, data timeout periods, data length restrictions and network performance.

The test cases may include:
tests to determine the fidelity of data transmitted from the client device to the server, or vice versa, via the said network, including the fidelity of one or more of the message headers, the message body and the message response code(s). Data fidelity testing may include testing one or more of textual data, generic binary data and binary data which consists of one or more digital media files.
tests to determine whether the said network makes use of particular transport protocols or versions thereof, including but not limited to testing for the usage of HTTP 1.1. Testing for particular transport protocols involves testing for the presence or absence of one or more specific protocol features, including but not limited to testing for data streaming on the said network, testing for the HTTP 1.1 Keep Alive feature and testing for ranged downloading features.
tests to determine data timeout period(s) for data transmitted from the client device to the server, or vice versa, via the said network.
tests to determine restrictions on the length or size of data transmitted from the client device to the server, or vice versa, via the said network.
tests to determine the performance of the said network by transmitting data from the client device to the server, or vice versa, via the said network and recording metrics as to the time difference between the sending and the receipt of the said data.

The tests may be executed, in whole or in part, one or more times over a given period of time as a means of testing the average or overall performance of the said network. The tests may be executed by means of a computer program on the said client device communicating with a computer program on the said server via the said network.

The network-based service may be a digital media subscription service, a digital media purchase service or any other network-based service. A digital media service is a network-based service where the data communicated consists of requests for digital media content and/or metadata and responses containing the requested metadata and/or digital media files.

The digital media includes of one or more of a song, a television show, an eBook or portion thereof, a computer game or any other discreet item of media content.

The client device can be a home computer, a mobile device, a gaming console, a vehicular-based media player, a television or any other computing device. The network can be the internet, a mobile network, a WAP network, any other communications network or a gateway to any such network.

The invention, in a related aspect, includes also a system for performing the above methods.

### DETAILED DESCRIPTION

### Definitions

For convenience, and to avoid needless repetition, the terms “music” and “media content” in this document are to be taken to encompass all “media content” which is in digital form or which it is possible to convert to digital form—including but not limited to books, magazines, newspapers and other periodicals, video in the form of digital video, motion pictures, television shows (as series, as seasons and as individual episodes), images (photographic or otherwise), music, computer games and other interactive media.

Similarly, the term “track” indicates a specific item of media content, whether that be a song, a television show, an eBook or portion thereof, a computer game or any other discreet item of media content.

The terms “playlist” and “album” are used interchangeably to indicate collections of “tracks” which have been conjoined together such that they may be treated as a single entity for the purposes of analysis or recommendation.

The verb “to listen” is to be taken as encompassing any interaction between a human and media content, whether that be listening to audio content, watching video or image content, reading books or other textual content, playing a computer game, interacting with interactive media content or some combination of such activities.

The terms “user”, “consumer”, “end user” and “individual” are used interchangeably to refer to the person, or group of people, whose media content “listening” preferences are analysed and for whom recommendations are made.

The term “device” refers to any computational device which is capable of playing digital media content, including but not limited to MP3 players, television sets, home computer system, mobile computing devices, games consoles, handheld games consoles, vehicular-based media players or any other applicable device.

The terms “MNO” and “ISP” are used interchangeably to refer to “Mobile Network Operators” or “Internet Service Providers”, being entities which provide access to a given network, such as the internet or a mobile network.

The term “network” refers to a communications infrastructure, such as the internet or a mobile network, which permits communications between devices.

The terms “gateway” and “network gateway” are used interchangeably to refer to a system, such as a computing system, which is used to access a particular MNO or ISP's network or to access other networks, such as the internet, from within a given network.

The terms “data fidelity” or “fidelity of data” are used interchangeably to refer to a check that when data is transmitted from one device to another then the data received by the second device is identical in all important respects (discounting expected or irrelevant changes) to that data which was sent by the first device.

The term “network-based service” is used to refer to a system which operates such that a client device communicates with a server to request information or data from that server, where the request from the client and the response from the server are communicated via a network. The service is delivered by a combination of software running on a client device performing the function of the application's interface to the end user or consumer, supported and complemented by services provided by software on a server which are accessed by the client device over a network.

### Overview

Rolling out any network-enabled service across different network types presents a variety of networking issues. Such issues are particularly evident when dealing with separate Mobile Network Operators (MNOs), due to inconsistencies of the Gateway infrastructure that MNOs provide.

While there are a large number of MNOs, each potentially having subtle differences in their network infrastructure, it is very likely that the problems that will be encountered will fall into distinct categories.

The present invention seeks to describe those broad categories of Network/Gateway issue and discloses tests to identify them at the earliest point, thus minimising the risk of rollout disruption.

The present invention is focused on disclosing a solution to the problem of establishing reliable, performant connectivity between a device, such as a computer or a mobile device, and the various backend services provided by a network-based service.

### Test Execution

To run the tests for a specific operator, ensure that you have an operator SIM in a compatible device connected to the operator's home network. Tests cannot be run in roaming mode or on any other hardware (such as PC emulators or unsupported phones).

Tests should be executed on the device using the Operator's default network settings (e.g. APN and proxy settings) and over the standard 3G network. Any advanced device connectivity features such as Wifi should be disabled in order to force access through the standard mobile data/voice carrying network.

### Categories of Tests

The present invention has at the core of its disclosed method a suit of tests which are used to interrogate a network and/or network gateway in order to determine the configuration of that network/gateway.

The broad categories of tests are disclosed in this section, while the reference design provided later discloses a detailed design for the implementation of the disclosed tests on a specific preferred embodiment of the present invention which, in the example reference design provided, is instantiated using the java computing language.

In this section, examples are presented for a service which runs on mobile devices operating on an MNO's mobile network, or WAP network. This is for illustrative purposes only, on the basis that such a scenario involves the broadest array of test cases disclosed by the present invention. Subsets of the test cases disclosed may be employed on other network types and/or use other devices where applicable.

### Data Fidelity Tests

Services running on mobile networks tend to function across WAP networks that have traditionally been used to provide WML based content for mobile devices. As with the general purpose internet, certain content types (mime types) can be translated in flight and others may not. Additionally, WAP networks often attempt to tailor general purpose web content to fit within the constraints of a small device. Example translations include:
Text, xml and html translated across different encodings (UTF, ISO 8859-1, ASCII etc.)
Natural language translation
Image scaling
Compression

However, where an application communicates using a binary protocol then it may be important that such messages not be interfered with in any way that would result in a non-identical message being delivered. Protocol layer compression or message chunking would not affect the end result, so would be permissible.

This issue is not restricted to message body content, but also affects:
Message headers (though the deliberate enrichment of the header to include MSISDN and roaming status is usually desirable)
HTTP response codes; (one MNO is known to intercept all non-success response codes and convert them to a redirect to an error page (on the assumption that the client is always a browser).

In such cases, the data fidelity tests are appropriate.

### Data Fidelity Tests: Test Approach

Send a series of known messages as well as random data from the client to the server to verify that they are received correctly and that they can be echoed back to the client without corruption. This should utilise the specific binary mime type required for the service, if any, as well as other binary and textual data types.

### Data Fidelity Tests: Notes

Failure to propagate HTTP response codes is strongly undesirable but may be tolerable if it only impacts the service provider's ability to resolve problems, since the application should still function adequately.

### Protocol Support Tests

These tests are applicable where a service makes use of HTTP 1.1 features to exchange data with application servers and to download content. Significantly, downloads utilise the ‘range’ facility (not present prior to HTTP 1.1) to allow resumption of an interrupted download. Other HTTP features such as connection Keep-alive are also beneficial to the smooth operation of a network-based service.

Additionally, when an MNO gateway proxies a request to the content servers, it can do so by either first downloading an entire binary file (to temporary memory on the gateway) before serving it to the client or by streaming data from, for example, content servers without intermediate storage. The streaming approach is preferable as it avoids introduction of unnecessary latency at the start of the request.

### Protocol Support Tests: Test Approach

Exercise the complete syntax set as used by the client (HTTP GET and POST)—specifically include range capability when accessing content.

Measure time to serve the first block of binary content and determine whether there is a consistent ‘dead time’ at the start of the request during which the gateway is requesting data from the content servers and not streaming it back in real time.

The server should also determine that only these requests were received during the test and that no additional side effects were detected (e.g. the additional unwanted adult content check that some MNOs may add to all requests). This is probably easiest to achieve by manually viewing server logs after tests are completed.

### Protocol Support Tests: Notes

Failure to stream is not critical, but the MNO should be pushed to enable it when possible. Additionally, a non streaming solution is likely to require more memory at the MNO gateway layer and may, therefore, necessitate maximum message size restrictions.

It will be easier to spot non-streaming dead time if the content server can be constrained to deliberately trickle data back over a period of say, a minute. Any gateway that can supply the first bytes of a response within the minute is demonstrably streaming.

### Timeout Tests

The MNO Gateway is essentially a proxy server and, like all proxies will almost certainly include timeout capability. This is to protect the server from outages/blockages in partner systems and allow expensive resources to be released.

However, if timeouts are set at an aggressively low duration (e.g. less than 30 seconds) then this can interrupt a significant proportion of otherwise valid service interactions and impact user experience.

Timeout detection can operate in two scenarios: passive and active. Passive timeouts occur when a period of time has elapsed since the last successful interaction (e.g. when waiting for the results of a lengthy calculation or database search). Active timeouts occur when a connection has been open for an excessive amount of time regardless of whether data is still flowing across it. (No MNO gateway has been observed to employ active timeouts).

### Timeout Tests: Test Approach

Write a server component that sleeps for the period of time specified in the incoming request before responding to the client. The client can then request a response time incremented in ˜10 second steps until a timeout is detected (or until it exceeds a ceiling of say 2 minutes).

The component can then be extended to include the ability to ‘trickle’ data back to the client (say 10 bytes per second) to determine whether an active timeout is also present.

### Timeout Tests: Notes

The service provider and the MNO need to agree what is an acceptable and recommended timeout. Current thinking, in the preferred embodiment is 30 seconds minimum, 2 minutes recommended.

### Length Restriction Tests

The MNO gateway may impose restrictions on the amount of data allowed to flow upstream from the mobile device or downstream to it in any one interaction. It may also vary this limit by HTTP method (GET/POST).

Limits on the upload message side are likely to be much smaller than download and could interfere with MusicStation's client-server communications. Limits to the download message size are more likely to truncate long music tracks (rather than interfere with the application protocol).

Additionally, certain handsets behave differently with large messages, adopting a chunking approach or not.

### Length Restriction Tests: Test Approach

Send a series of messages from the client to the server to determine the maximum upload message size in terms of maximum GET query string and maximum POST message size. Assume that GET length of 1024 bytes and a POST size of 5 Mb are sufficient for our needs so no need to test beyond that.

Reverse the emphasis of the test and request an increasingly large response from the server to gauge the maximum download size. Assume that a 10 Mb response is sufficient for our needs.

The data passed should be random/complex so as to not be readily compressible (in case a deflation step in the infrastructure distorts the results).

### Length Restriction Tests: Notes

The actual required upload/download targets may actually be much lower with specific MNOs.

### Performance Tests

In addition to general acceptability of the Gateway's functionality, it is also appropriate to measure its responsiveness over the course of a day (or longer) to determine whether it (or indeed the internet infrastructure that it relies on) is constrained at any times. Some territories (e.g. South Africa) may require localisation of content to overcome the responsiveness of the internet itself.

For this to work, a long running client would need to started on a phone with adequate charge (e.g. with charger connected) in a place with reliable signal strength and left to run for a suitable period of time (say 24 hours). The actual tests would be simple request/response messages similar in size to those used by the service's application. Accurate elapsed time readings would be taken and uploaded to the server for collation and analysis.

The key factors in this to analyse are:
1. Networking latency
2. Maximum message throughput
3. Daily performance profile

### Reference Design

A suite of J2ME test cases has been developed alongside a set of server side functions (Servlets) to support each of the disclosed test scenario and to collate results. The overall suite has been provided for download and may be executed during initial MNO engagement. Clearly, intense tests such as a network soak that runs for many hours/days may not be appropriate during initial contact—indeed permission might be required in order to run such a test.

Onscreen prompting and feedback is, in the preferred embodiment, minimal and results are collated and analysed by backend servers. Each test application need only, in this preferred embodiment, show a progress bar (or similar UI cue) to indicate that the application is running.

The download of the Midlet as well as the hosting of the server side components need not be on the production hardware for the service. It should, however, be a pre-production quality web facing infrastructure with ample capacity so as not to skew/constrain test results.

This section discloses details of one preferred embodiment of the present invention, wherein the suite disclosed is implemented as a set of server- and client-based components developed in the Java computing language.

While the example embodiment described herein is of a Java instantiation, the present invention does not require the use of any specific computing language in order to be implemented in the form of an automated tool.

### Server Components

The following Servlets form the basis of the test suite. They may be parameterised to vary precise behaviour. In this way a single Servlet class can cater for several different test scenarios by configuring parameterised instances against different URLs. Both the parameters and the functionality are described below.

There is no requirement that any specific embodiment of the present invention implement all of the server-side components disclosed—any combination of individual server-side components may be omitted if desired.

### EchoServlet

Echoes content back to the client, optionally performing server side verification that the content matches expectations.

### EchoServlet: Parameters

bodyExpectation: reference to a server side resource containing the expected body content that this Servlet will receive.

headerExpectation: reference to a server side resource containing the expected headers that this Servlet will receive.

Note: the expectation is not necessarily an exact match—additional enrichment headers will be ignored. Headers expectations are expressed in the form of a Java properties file consisting of keys and their values. The value of headers may (optionally) be omitted (a Regex—regular expression—may be used to improve flexibility)—in this case the Servlet will just confirm that a header exists with any non-null value.

### EchoServlet: Functionality

The Servlet starts by verifying that it is invoked with content and headers that meet its expectations. If expectations are not met, the Servlet will return an HTTP response code of 500 and numeric content indicating the nature of the expectation failure, specifically:
1. Failed body expectations
2. Failed header expectations
3. Failed body and header expectations

If the request meets expectations (or no expectations are set) the Servlet simply echoes back the exact body and header content that it has been invoked with. The client may then perform its own verification.

### ResponseCodeServlet

Generates HTTP response codes.

### ResponseCodeServlet: Parameters

Response: the response code to set.

### ResponseCodeServlet: Functionality

The Servlet must be invoked with a single numeric parameter ‘response’ indicating the response code to set. The Servlet simply parses the code from the request and responds by setting it as the HTTP status code.

### RangeServlet

Satisfies range based requests.

### RangeServlet: Parameters

Range headers as per the HTTP 1.1 Range specification.

### RangeServlet: Functionality

The Servlet has a small hard-coded set of content to serve, and will respond either with the whole message or a chunk of it depending on whether Range headers have been specified. Range protocol specific response codes are set to indicate partial content as appropriate.

### DelayerServlet

Satisfies requests (with random content) but spreads response over a period of time and (optionally) several chunks.

### DelayerServlet: Parameters

length: the per-chunk length of data to serve.

sleep: time in milliseconds that the Servlet will sleep between serving each chunk of content.

chunks: specifies the number of chunks of content to be served (default is 1 chunk—i.e. the whole content un-chunked)

### DelayerServlet: Functionality

The Servlet starts by reading the request to determine whether the chunks and/or delay parameters have been supplied or must be defaulted.

It will then serve a chunk of data at a time, sleeping between each chunk:

For each chunk
1. Write random data of length ‘length’
2. Flush response
3. Sleep for period ‘sleep’

End for

The Servlet will close the response only after all chunks have been served.

### LengthServlet

Serves random data of the requested length.

### LengthServlet: Parameters

Length—the length of random data to serve.

### LengthServlet: Functionality

This Servlet will read the ‘length’ parameter out of the request, and respond by sending that number of bytes of random binary data in the ‘application/x-musicstation’ mime type.

It is up to the client to verify that the correct number of bytes has been received.

### ResultsServlet

Stores the results of the Tests for subsequent analysis

### ResultsServlet: Parameters

None.

### ResultsServlet: Functionality

This Servlet is invoked with an XML results set object that is parsed and persisted to a robust database for subsequent analysis.

The ResultsPersister class is used to manage database access and to correlate the first result for a specific test with all the others that follow, comprising a test suite.

### Client-side Tests

Disclosed below are specific tests which are executed, in the preferred embodiment presented as an example herein, to interrogate the network by utilising the server-side components disclosed previously. There is no requirement that any embodiment of the present invention either employ identically or similarly named server-side components or make use of any specific computing language for such an embodiment.

Similarly, there is no requirement that any specific embodiment of the present invention implement all of the tests disclosed—any combination of individual tests may be omitted if desired.

The reference design for a client test suite described herein comprises a J2ME application capable of performing the various combinations of tests required. It is unsigned and will prompt once (at start up) for all network usage. Test results are uploaded to the server, so no local device storage is required.

These tests should be run using modern mobile devices that are supported by the main application for the service for which the present invention is implemented. Where specific devices are known to behave differently in light of large messages compared to others, it is recommended that each such subclass of device be used to perform the tests disclosed here.

In the preferred embodiment, the first client component that the end user will see is a basic config/options launcher page. This is responsible for setting expectations as to the duration of the test and the amount of data that will be transferred (so that billing data charges can be anticipated or obviated by white listing).

It also captures three elements of data:
1. The MNO name and territory, e.g. “Vodafone Australia”
2. The device id, e.g. “Nokia 6500”
3. The type of test to perform: “basic”, “basic plus performance” or “basic plus soak” (There is no need to perform performance then soak as the first iteration of the soak test is, effectively, the same as the performance test

The time and data estimates will be updated to reflect the type of test selected.

Once the requisite data has been entered, the test can be initiated. This will include making the first server call to initialise the test session.

The user is, in the preferred embodiment, typically presented with a simple ‘tests executing’ page while the tests are being run. This comprises of a progress bar (giving an indication of time remaining to complete the tests) and a cancel button. Once the tests are complete, they can be repeated or the application can be terminated.

In the preferred embodiment, the running application is able to run while minimised so as not to require exclusive use of the device, which is an especial consideration when running soak tests.

A cancelled test may still have recorded results for basic connectivity, so is not worthless.

### Download Length Test

Determines whether the network implements maximum content length restrictions up and downstream.

### Download Length Test: Execution

Using the LengthServlet:
Request content of 1 kb, 256 kb, 512 kb, 1 Mb, 3 Mb, 5 Mb, 10 Mb in length and ensure that the content is served correctly

Determine the largest request to have been served correctly.

### Download Length Test: Results

All length results will be expressed in terms of the maximum message size to have succeeded, such as “largest successful download=10485760 (bytes)”

### Timeout Test

Determines whether the network implements timeouts for long running requests. Estimates the threshold for such timeouts.

### Timeout Test: Execution

Using the DelayerServlet:
Request content (in one chunk) with a delay of 1, 10, 30, 45, 60, 90 and 180 seconds (passive timeout)

### Timeout Test: Results

All timeout results will be expressed in terms of the maximum delay that succeeded, e.g.:
last successful request period=180000 (milliseconds)

### Range Test

Determines whether the network supports range requests.

### Range Test: Execution

Using the RangeServlet:
Make an ordinary request to access the binary content it serves
Re-request the content using 2 separate range requests of roughly equal length
Assemble the ranged content and confirm that it matches the original that was requested as a whole

### Range Test: Results

Results are expressed as a simple Boolean pass/fail

### Keep Alive Test

Determines whether the network supports HTTP Keep-Alive.

### Keep Alive Test: Execution

Using the LengthServlet:
May an arbitrary request
Check that the Connection: close header has not been set

### Keep Alive Test: Results

Results are expressed as a simple Boolean pass/fail

### Streaming Test

Determines whether the network support streaming of content or whether it must download an entire file before serving it to the device.

### Streaming Test: Execution

Using the DelayerServlet:
Make a request for 60 chunks of data, delayed by 2 seconds each
Time the elapsed interval before the first byte of content is served
If the first chunk of data is served within the 2 minutes taken to serve the entire response, then the network must have streamed content

### Streaming Test: Results

Results are expressed as Boolean pass/fail including time taken to serve the first chunk of data, e.g. First byte served in:=895 milliseconds

### Body Fidelity Test

Tests whether the network interferes in any way with binary data passed over it.

### Body Fidelity Test: Execution

Using the EchoServlet:
Send and verify the following message set:
   1. The entire range of possible binary values in a sequence
   2. An audio file
Ensure that the messages are echoed back unchanged
Ensure that no unexpected response codes are generated

### Body Fidelity Test: Results

Results are expressed as a simple Boolean pass/fail

### Header Fidelity Test

Tests whether the network interferes in any way with HTTP headers passed over it.

### Header Fidelity Test: Execution

Using the EchoServlet:
Send and verify that the various HTTP headers that the MusicStation/PN+client are propagated unchanged

### Header Fidelity Test: Results

Results are expressed as a simple Boolean pass/fail

### Response Code Test

Tests whether the network interferes with or attempts to translate HTTP response codes.

### Response Code Test: Execution

Using the ResponseCodeServlet:
Request the entire range of HTTP response codes
Verify that they are returned correctly

### Response Code Test: Results

Results are expressed as pass/fail/warning; where several obscure HTTP response codes are specified as non-essential (i.e. not currently in use by Omnifone systems).

### One Off Performance Test

Determines performance characteristics of the network—primarily in terms of response time. By repeating elements of the maximum length tests and recording the time taken to execute them.

### One Off Performance Test: Execution

Using the EchoServlet:
Execute an HTTP POST request of 512, 1024 and 2048 kilo bytes of random data and ensure the exact content is returned—measure time taken for each to complete. Do not request larger up/download message than the largest permissible (as established in the earlier ‘Basic Maximum Length’ test)

Using the LengthServlet:
Request content of 4 and 6 mega bytes in length and ensure that the content is of the correct length—measure time taken for each to complete. Do not request larger up/download message than the largest permissible (as established in the earlier ‘Basic Maximum Length’ test)

Repeat both tests 10 times.

### One Off Performance Test: Results

All results are categorised and reported in terms of the milliseconds required to execute. This takes the form:
performance-<Class of test>-<message size>-<iteration>e.g.:
performance-post-1024 k-0=1500
(the first iteration of the 1024 kb POST test took 1.5 seconds)
performance-download-6 mb-9=5000
(the 10^{th} iteration of the 6 Mb download test took 5 seconds)

### Performance Soak Test

Determines performance characteristics of the network—throughout the day at hourly intervals. Runs for 24 hours (though spends much of this time sleeping, waiting for the next timing interval).

### Performance Soak Test: Execution

Calculates 24 hourly slots.
Executes the standard performance test.
Sleeps until the next slot is due (not for a whole hour as the tests themselves will take time to execute)
Continues until all 24 hourly slots have been exhausted

### Performance Soak Test: Results

Results are recorded hourly as per the one off performance test. It is possible to interrupt the soak test and still use whatever results have already been recorded.

1. A method for automatically identifying potential issues with the configuration of a network by using the combination of a client device and a server to execute one or more test cases on the network and thereby determine those characteristics of the network which are relevant to the implementation of a network-based service on the network.

2. The method of claim 1 where the characteristics include one or more of data fidelity, protocol support, data timeout periods, data length restrictions and network performance.

3. The method of claim 1 where the test cases include tests to determine the fidelity of data transmitted from the client device to the server, or vice versa, via the network.

4. The method of claim 3 where the data fidelity includes the fidelity of one or more of the message headers, the message body and the message response code(s).

5. The method of claim 1 where the test cases include tests to determine whether the network makes use of particular transport protocols or versions thereof, including but not limited to testing for the usage of HTTP 1.1.

6. The method of claim 5 where the testing for particular transport protocols involves testing for the presence or absence of one or more specific protocol features, including but not limited to testing for data streaming on the said network, testing for the HTTP 1.1 Keep Alive feature and testing for ranged downloading features.

7. The method of claim 1 where the test cases include tests to determine data timeout period(s) for data transmitted from the client device to the server, or vice versa, via the network.

8. The method of claim 1 where the test cases include tests to determine restrictions on the length or size of data transmitted from the client device to the server, or vice versa, via the network.

9. The method of claim 1 where the test cases include tests to determine the performance of the network by transmitting data from the client device to the server, or vice versa, via the network and recording metrics as to the time difference between the sending and the receipt of the data.

10. The method of claim 1 where the tests are executed, in whole or in part, one or more times over a given period of time as a means of testing the average or overall performance of the network.

11. The method of claim 1 where the tests are executed by means of a computer program on the client device communicating with a computer program on the server via the network.

12. The method of claim 1 where the data fidelity includes testing one or more of textual data, generic binary data and binary data which consists of one or more digital media files.

13. The method of claim 1 where the network-based service is a digital media subscription service, a digital media purchase service or any other network-based service.

14. The method of claim 1 where the digital media includes one or more of a song, a television show, an eBook or portion thereof, a computer game or any other discreet item of media content.

15. The method of claim 1 where the client device is a home computer, a mobile device, a gaming console, a vehicular-based media player, a television or any other computing device.

16. The method of claim 1 where the network is the internet, a mobile network, a WAP network, any other communications network or a gateway to any such network.

17. (canceled)

18. A system for automatically identifying potential issues with the configuration of a network, in which the system uses the combination of a client device and a server to execute one or more test cases on the network and thereby determines those characteristics of the network which are relevant to the implementation of a network-based service on the network.

19. The system of claim 18 where the characteristics include data fidelity.

20. The system of claim 18 where the characteristics include protocol support.

21. The system of claim 18 where the characteristics include data timeout periods.

22. The system of claim 18 where the characteristics include data length restrictions.

23. The system of claim 18 where the characteristics include network performance.
